(19) United States
(12) Patent Application Publication
(10) Pub. No.: US 2004/0096074 A1
(43) Pub. Date: May 20, 2004

(54) Method and apparatus for auto-detection of speakers connected to a home theater system

(75) Inventors: Raymond Bontempi, Jamison, PA (US); John Kamieniecki, Lafayette Hill, PA (US)

Correspondence Address: VOLPE AND KOENIG, P.C., DEPT. MOT, UNITED PLAZA, SUITE 1600, 30 SOUTH 17TH STREET, PHILADELPHIA, PA, 19103, US

(73) Assignee: General Instrument Corporation, Horsham, PA (US)

(21) Appl. No.: 10/299,562

(22) Filed: Nov. 19, 2002

(51) Int. Cl. H04R 5/02

(52) U.S. Cl. 381/300

(57) ABSTRACT

A method and apparatus is disclosed for automatically detecting the current speaker configuration of a home theater system. An audio/video receiver of a home theater system automatically detects which sound channels have speakers attached so that audio output may be provided according to the current speaker configuration.

### BACKGROUND

The invention relates to home theater systems and more particularly to automatic detection of speakers connected to a home theater system.

Home theater systems typically include a plurality of speakers as well as an audio/video receiver for providing a surround sound feature for audio input to the receiver. The plurality of speakers are typically connected to the receiver at sound channels. The speakers are preferably connected to specific sound channels so as to create a surround sound effect. For example, one sound channel, typically the center channel, may correspond to the dialogue of a television program while other sound channels correspond to various types of background noise.

Current home theater systems, however, are unable to identify their current speaker configuration, i.e. the sound channels of the receiver that have speakers actively connected to them. Without knowing the current speaker configuration, it is impossible for a home theater system to determine the best audio output for different audio inputs. Furthermore, if the home theater system is incorrectly configured, the user may fail to receive some or all of the audio content. For example, if a user only has two speakers to attach to the receiver of a home theater system and neither of those speakers are connected to the center channel, but the home theater system is set to surround sound mode, the user will not hear any dialogue while watching a movie. In other cases, a user may simply have the speakers connected to the wrong channel. For example, the speaker meant to be in the rear left position may be plugged into the center channel.

To deal with the inability of home theater systems to automatically detect and process which sound channels have speakers attached, some home theater systems have user menus that allow the user to configure how many speakers they have connected to the receiver. That is, if the user only has two speakers and those speakers are connected to the center channel and the right front channel, for example, the user can indicate that configuration to the receiver so that the receiver may direct all of the audio to those two channels.

Such systems, however, are inconvenient and are not user friendly in that they require an additional step as well as a certain level of technical expertise on the part of the user. For example, such systems are useless where a user never configures the equipment or simply configures the equipment incorrectly, either with respect to an incorrect number of speakers or an incorrect type etc. Such systems are also useless where a user correctly configures the equipment, but then changes the configuration (i.e. adds or removes speakers) and fails to reconfigure the equipment via the various setup screens.

It would therefore be desirable to automatically detect the speaker configuration of a home theater system so that the home theater system may be automatically configured properly upon being turned on without requiring any additional steps on the part of a user.

### SUMMARY

The invention is a method and apparatus for automatically detecting the current speaker configuration of a home theater system. An audio/video receiver of a home theater system automatically detects which sound channels have speakers attached so that audio output may be provided according to the current speaker configuration.

### BRIEF DESCRIPTION OF THE DRAWING(S)

FIG. 1 is a diagram showing a method for automatically detecting a speaker configuration connected to a home theater system so that audio output may be provided according to the current speaker configuration, in accordance with the preferred embodiment of the invention.

FIG. 2 is an audio/video receiver for automatically detecting a speaker configuration connected to a home theater system so that audio output may be provided according to the current speaker configuration, in accordance with the preferred embodiment of the invention.

### DETAILED DESCRIPTION OF THE PREFERRED EMBODIMENT(S)

For sake of clarity, a typical audio/video receiver includes a set of send/receive (s/r) contacts for each of the receiver's sound channels. Further, as mentioned, a speaker may be connected to each of the receiver's sound channels. Therefore, to detect which sound channels have speakers attached, the method checks each set of s/r contacts for the presence of a speaker.

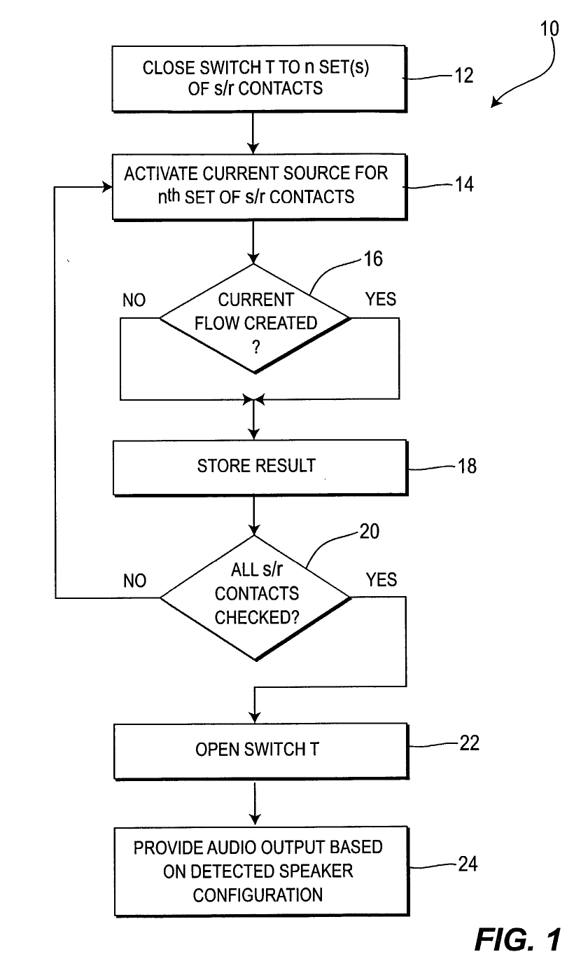

Referring now to FIG. 1, a method 10 is shown for automatically detecting the speaker configuration of a home theater system so that audio output of the home theater system may be provided based on the detected speaker configuration. The method begins with step 12 by closing a switch, say switch T, to n set(s) of s/r contacts. Closing switch T will connect a current generator circuit to each set of s/r contacts. Any type of switch may be used to connect the current generator circuit to each set of s/r contacts. By way of example, a matrix or multi-point switch may be used.

Once the switch is closed, the method proceeds to step 14 where a current source is activated for the n^{th} set of s/r contacts. The current source may be provided using any type of current generator circuit. When activating the current source, it is preferable that the current is slowly increased over a predetermined time interval.

Once the current source is activated, the method, in step 16, determines whether a current flow is created for the n^{th} set of s/r contacts. A “yes” result is provided where a current flow is established and a “no” result is provided where no current flow is established. The yes/no results may be stored in step 18.

Once a yes/no result has been stored for the n^{th} set of s/r contacts, the method proceeds to step 20. In step 20, the method determines whether every set of s/r contacts, and thus all of the sound channels and speakers, have been checked. If there are additional sets of s/r contacts to check, the method returns to step 14 and starts over with the next set of s/r contacts. If, in contrast, every set of s/r contacts of the receiver have been checked, switch T is opened (step 22) and audio output is provided based on the detected speaker configuration (step 24). For example, if every sound channel has a speaker attached to it, the receiver will output audio to all of those speakers in normal surround sound mode. If, in contrast, it is detected that one or more speakers are missing, the receiver will adjust the audio output so that audio is output to the sound channels having speakers attached to them.

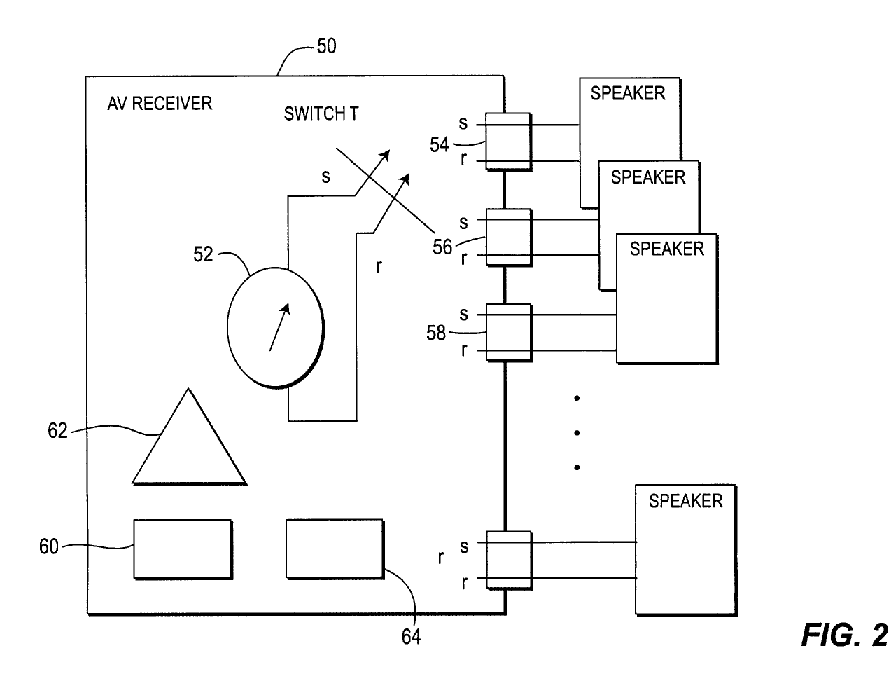

Referring now to FIG. 2, an audio/video receiver 50 in accordance with the present invention is shown. The receiver 50 includes a switch T 52 having a plurality of sets of s/r contacts. The number of sets of s/r contacts of switch T 52 corresponds to the number of sets of s/r contacts 54, 56, 58 . . . n of the receiver 50. Each set of s/r contacts 54, 56, 58 . . . n corresponds to a sound channel of the receiver 50 and potentially a speaker.

A first processing means 60 may be provided for controlling switch T 52 so that a current generator circuit 62 may be connected to s/r contact sets 54, 56, 58 . . . n. The first processing means 60 may also be used to selectively apply the current generated by current generator circuit 62 to s/r contact sets 54, 56, 58 . . . n, as desired, so as to check each set of s/r contacts 54, 56, 58 . . . n for the presence of a speaker. The first processing means may be any type of computer processor capable of controlling switch T 52 and current generator circuit 62.

A second processing means 64 may be provided for identifying sound channels having speakers attached by determining whether a current flow is established for a sound channel when a current flow is delivered thereto. The second processing means 64 may store a yes/no result for that determination for each sound channel and process any audio received by the receiver 50 accordingly. That is, audio received by the receiver will be outputted based on the speakers connected to the receiver 50. The second processing means 64, like the first 60, may be any type of computer processor for performing the functions described above.

As explained above, the receiver 50 automatically detects which sound channels have speakers attached so that audio received by the receiver is output accordingly. It is important to note that the first 60 and second 64 processing means may also be a single processor adapted to perform the functions of both processing means 60, 64. It is also important to note that the processing means 60, 64 may be adapted so that the receiver 50 automatically determines which of its sound channels currently have speakers attached each time the receiver 50 is activated or otherwise turned-on.

Although the present invention has been described in detail, it is to be understood that the invention is not limited thereto, and that various changes can be made therein without departing from the spirit and scope of the invention, which is defined by the attached claims.

What is claimed is:

1. A method for automatically detecting a current speaker configuration of a home theater system so that audio output may be provided according to the current speaker configuration, the method comprising:
a) identifying which sound channels of an audio/video receiver have speakers attached to them; and
b) outputting audio received by the audio/video receiver to the identified sound channels.

2. The method of claim 1 wherein the step of identifying which sound channels of an audio/video receiver have speakers attached to them further comprises:
a) attaching a current source to each sound channel of the receiver;
b) activating the current source for each sound channel of the receiver; and
b) determining whether a current flow is established for any of the sound channels of the receiver.

3. The method of claim 2 wherein the step of attaching a current source to each sound channel of the receiver further comprises:
a) closing a switch so as to connect send/receive contacts of a current generator with send/receive contacts of each sound channel of the receiver.

4. The method of claim 2 wherein the step of activating the current source for each sound channel of the receiver is performed successively for each sound channel of the receiver.

5. The method of claim 2 wherein the step of activating the current source for each sound channel of the receiver is selectively performed for each sound channel of the receiver.

6. A method for automatically detecting a current speaker configuration of a home theater system so that audio output may be provided according to the current speaker configuration, the method comprising:
a) attaching a current source to each sound channel of the receiver;
b) activating the current source for each sound channel of the receiver;
c) determining whether a current flow is established for any of the sound channels;
d) identifying the sound channels having a current flow; and
e) outputting audio received by the audio/video receiver to the identified sound channels.

7. The method of claim 6 wherein the step of attaching a current source to each sound channel of the receiver further comprises:
a) closing a switch so as to connect send/receive contacts of a current generator with send/receive contacts of each sound channel of the receiver.

8. The method of claim 6 wherein the step of activating the current source for each sound channel of the receiver is performed successively for each sound channel of the receiver.

9. The method of claim 6 wherein the step of activating the current source for each sound channel of the receiver is selectively performed for each sound channel of the receiver.

10. An audio/video receiver for automatically detecting a current speaker configuration of a home theater system so that audio output may be provided according to the current speaker configuration, the receiver comprising:
a) an adjustable current generator;
b) a plurality of sound channels for connecting speakers to the receiver;
c) a first processing means for controlling a switch to connect the adjustable current generator to the plurality of sound channels and for activating the current generator so as to selectively deliver a current to the plurality of sound channels; and
d) a second processing means for identifying sound channels having speakers attached and for outputting audio received by the audio/video receiver to the identified sound channels.

11. The audio/video receiver of claim 10 wherein the second processing means identifies sound channels having speakers attached by determining whether a current flow is established when the first processing means delivers a current flow to a sound channel.

12. The audio/video receiver of claim 10 wherein the first and second processing means is a single processing means.

13. The audio/video receiver of claim 10 wherein the sound channels having speakers attached are identified each time the audio/video receiver is activated.
